(19) United States
(12) Patent Application Publication
(10) Pub. No.: US 2016/0078776 A1
(43) Pub. Date: Mar. 17, 2016

(54) TONGUE TWISTER GAME AND METHOD OF PLAY

(71) Applicants: Michael J. Kiely, Alexandria, VA (US); Adam James Oliveira, Bridgewater, MA (US)

(72) Inventors: Michael J. Kiely, Alexandria, VA (US); Adam James Oliveira, Bridgewater, MA (US)

(21) Appl. No.: 14/852,985

(22) Filed: Sep. 14, 2015

Related U.S. Application Data
(60) Provisional application No. 62/050,742, filed on Sep. 15, 2014.

(51) Int. Cl. G09B 17/00; G09B 19/22

(52) U.S. Cl. CPC G09B 17/00; G09B 19/22

(57) ABSTRACT

A game and a method for playing an educational game for teaching players speech quality improvement comprising: providing at least one player with a twist card; picking a player to start the game; a current player drawing a tongue twister card; speaking the text of the tongue twister card by the current player; and collecting a game point if the tongue twister text is spoken correctly and the drawing of at least one twist card by the current player. The game may continue with a next player repeating the above steps.

### CROSS-REFERENCE TO RELATED APPLICATION

This application claims the benefit of priority of U.S. provisional application No. 62/050,742, filed Sep. 15, 2014, the contents of which are herein incorporated by reference.

### BACKGROUND OF THE INVENTION

The present invention relates to educational games and, more particularly, to an educational game for improving speech quality.

Speaking tongue twisters can be an effective means for entertainment and speech therapy, but due to their simple and repetitive concept most people quickly lose interest. This lack of interest is most unfortunate for patients suffering from speech related disorders that can greatly improve their speaking ability with the use of tongue twisters, but do not want to continually recite the same, old repetitive phrases in the traditional method.

Currently, other devices rely on a simpler method of reading a tongue twister. This simpler method is usually just reading a physical card or a digital version through mobile applications where a person reads a tongue twister in their own voice, which can become dull and tedious and decrease interest in learning.

As can be seen, there is a need for game, educational and entertaining, that improves speech quality.

### SUMMARY OF THE INVENTION

In one aspect of the present invention, an embodiment card game comprises a plurality of tongue twister cards, the tongue twister card having a text of a tongue twister presented on a surface thereof; the text of the tongue twister to be spoken by a player during the game; and a plurality of twist cards, the twist cards having indicia presented on a surface thereof, the indicia specifying an additional condition under which the player is required to execute the speaking of the tongue twister. In certain embodiments, the twist card comprises a persona card, the persona card having an identity of a persona presented on a surface thereof, wherein the persona is the additional condition. In other embodiments, the persona card further comprises a presentation of an additional start or finish action as the additional condition. In other embodiments the twist card comprises an offense action card, the offense card having a presentation of the additional condition under which an opponent is to execute the speaking of the tongue twister. In yet another embodiment, the twist cards comprises a defense action card, the defense action card having a presentation of the additional condition under which a player of the defense action card is to execute the speaking of the tongue twister.

In another aspect of the present invention, method for playing an educational game for teaching players speech quality improvement comprises: providing at least one player with a twist card; picking a player to start the game; drawing a tongue twister card for each player when it is the player's turn; the tongue twister card having a text of a tongue twister presented on a surface thereof; the player speaking the text of the tongue twister card; and collecting a game point if the tongue twister text is spoken correctly and drawing at least one twist card. Other embodiments entail playing a twist card, wherein the twist card comprises a persona card, the persona card providing an identity for a persona, wherein the player speaks the tongue twister text according to an attribute of the persona.

In other aspects the method comprises playing a twist card, wherein the twist card includes an offense action card that provides an additional condition for an opponent to execute in order to collect a game point. In yet other embodiments of the invention the method the opponent performing the additional condition specified on the offense action card. Other aspects of the method includes playing a twist card, wherein the twist card comprises a defense action card, the defense action card specifying an additional condition for the player playing the defense action card to execute in order to collect a game point and may include the player playing the defense action card performing the additional condition specified on the defense action card.

These and other features, aspects and advantages of the present invention will become better understood with reference to the following drawings, description and claims.

### BRIEF DESCRIPTION OF THE DRAWINGS

FIG. 1 is a perspective view of the cards and game setup.

FIG. 2 is a flowchart illustrating rules and flow of the game.

FIG. 3 is a continuation of the flowchart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for playing an educational game for teaching players speech quality improvement comprising: providing at least one player with a twist card; picking a player to start the game; a current player drawing a tongue twister card; speaking the text of the tongue twister card by the current player; and collecting a game point if the tongue twister text is spoken correctly and the drawing of at least one twist card by the current player. The game may continue with a next player repeating the above steps.

This present invention improves upon the traditional methods by having players improve their speech quality by offering a new method of speaking tongue twisters over the traditional approach. This new method will expand on the same concept as the old way and improve on it by incorporating attributes, such as voices and accents, which also improves on creativity and social skills.

The present invention may be used in a variety of contexts such as a speech therapy tool in that field and outside of it. It could also be utilized through a number of technologies such as, but not limited to: apps, electronic and/or computer devices. Alternatively it could be set up and added to in different variations to make other tabletop games. This method could be used in additional fields, such as government use or educational use.

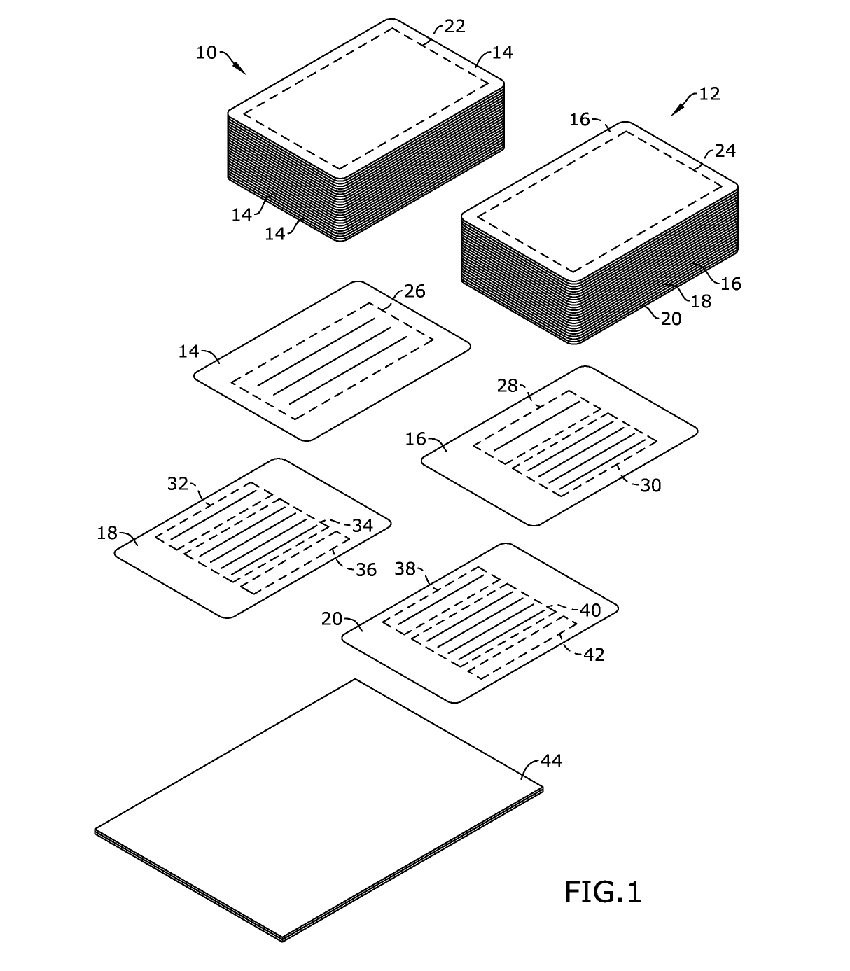

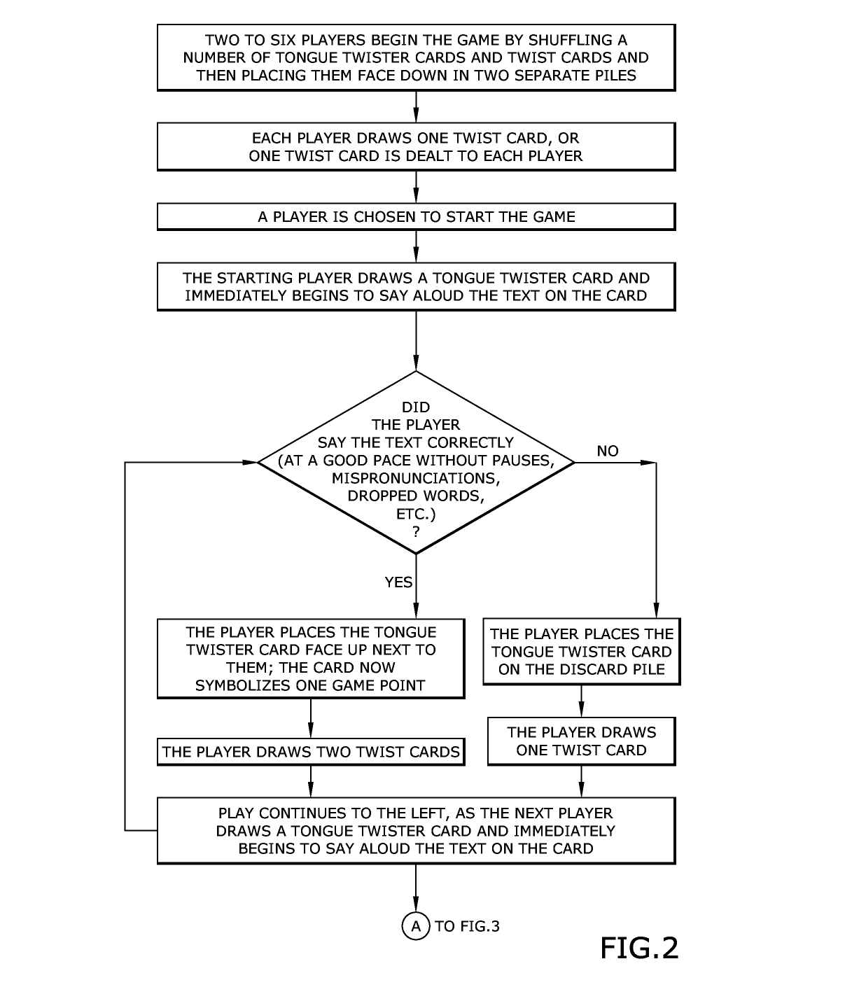

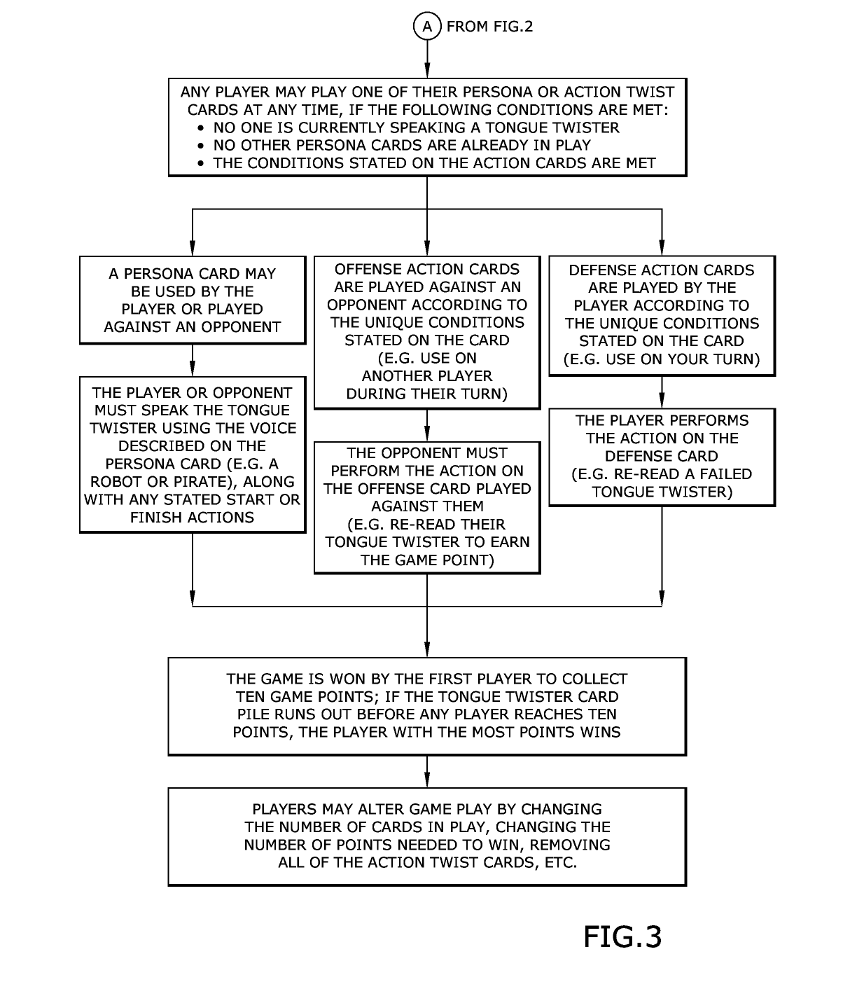

As is illustrated in FIGS. 1 through 3, a method for playing a game to improve speech quality may include a plurality of cards. The plurality of cards may include a plurality or set 10 of tongue twister cards 14 and a plurality or set 12 of twist cards 16. The tongue twister cards 14 have a tongue twister, such as “Fred fried fresh fish fritters”, printed on a text area 26 on at least one surface of the tongue twister card 14. A logo area 22 may be provided on an opposite surface of the tongue twister cards 14, so that the cards may be readily sorted for game setup. Preferably, each tongue twister card 14 contains a different tongue twister printed in the text area 26.

The set 12 of twist cards 16 provide a twist, or other variation, over the traditional tongue twister use of simply reciting the tongue twister printed on the tongue twister card 14. The set 12 of twist cards 16 may include a plurality of persona cards 16, wherein at least one surface of the card 16 may have a persona card title area 28, and a persona card instruction area 30. The title area 28 may provide an identification of a character, personality, trade, animal, or the like, (e.g. a robot or a pirate) and the instruction area may include instructions for the player to speak according to an attribute, such as a voice, an accent, a song, or a mannerism, associated with the identification provided in title area 28.

Alternatively, the instructions 30 may include performing or acting as if the player were a person or character associated with the identification provided in the title area 28. Additional instructions start and/or finish actions may also be provided in the instruction area 30. In each instance the player, may be required to execute the instructions while attempting to read and speak the tongue twister contained on a drawn tongue twister card 14. In play, a persona card 16 may be used by the player during their turn, or may be used against an opponent.

The twist cards 16 may further comprise a plurality of action cards, such as a plurality of offense cards 18 and a plurality of defense cards 20. The offense cards 18 may comprise an offense action title area 32, an offense card instruction area 34, and an offense label area 36. By way of example, an offense action card 18 may only be played against an opponent according to the unique conditions stated on the offense action card 18 (e.g. use on another player during their turn) The opponent must then perform the action on the offense card played against them (e.g. re-read their tong twister to earn the game point).

Similarly, the defense cards 20 may comprise a defense action title area 32, a defense card instruction area 40, and a defense card label area 42. In play, defense action cards 20 are played by the player according to the unique conditions stated on the card (e.g. use on your turn). The player would perform the action on the defense card, (e.g. re-read a failed tongue twister from the discard pile).

A manual 44 may be supplied to help with information regarding the rules of the game. The game may include at least one player.

In certain embodiments, the game may be played with cards, board components, other written apparatus, or the like. The game may also be played using an electronic or computer device such as on a mobile application. In certain embodiments, timers, dials, dice, and additional card types may be used.

In certain embodiments, a voice recognition and a playback may be utilized in connection with the game and provided on a computing device, such as a mobile device, tablet, computer, or discrete electronic device. By way of example, a tongue twister application for a computing device where the player's recitation of the tongue twister is received by a microphone input of the computing device. The player's recitation of the tongue twister is analyzed for correctness in reading the tongue twister.

According to this embodiment, for example as part of a speech therapy regimen, a patient may be able to play the game individually, and receive feedback in terms the voice recognition module scoring of their ability to enunciate the tongue twister. Similarly, the playback module may provide the patient the opportunity to listen to their recorded speech, while not involved in the task of speaking, so that they may assess their own performance of and enunciation.

Alternatively, the voice recognition module may be utilized as a scoring referee during multi player game play. In this situation, the scoring and award of points is based on the voice recognition module affirming or denying that a player has properly recited the subject tongue twister.

The use of the plurality of cards allows for an extended timeframe during which the game may be played so that there may be increased learning of speech skills. The plurality of persona cards 14 may allow for variation of the tongue twisters stated and provides a lively interaction between players. The text on the plurality of cards may vary and more may be added to improve the game.

In certain embodiments, the rules of the game may be, but not limited to, as follows:
a) The plurality of cards may be separated into two separate piles, a tongue twister card pile 10 and a twist card pile 12. The individual piles may then be shuffled and placed in a downwardly facing position.
b) Each player may initially draw a twist card 16 from the top of twist card pile 12, or alternatively, each player may be dealt a twist card 16 from the deck.
c) Choose a player to start first.
d) A first player may choose a tongue twister card 14 from the tongue twister deck 10 and attempt to correctly speak the text 26 of the tongue twister card 14 in order to score a Game Point and earn additional twist cards 12. The text 26 of the tongue twister card 14 may be something like “Fred fried fresh fish fritters”, or the like.
e) If the tongue twister card 14 is spoken correctly, the player may keep that tongue twister card 14, which represents a Game Point and draws at least one twist cards 12 ending their turn. In certain embodiments, two twist cards 12 may be selected.
f) If the tongue twister card 14 is spoken incorrectly, the player may draw a twist card 12 ending their turn.
g) The next player may then pick a tongue twister card 14 from the deck 10 and repeat steps e) and f).

During play according to the foregoing, any player may play one of their twist cards 16 at any time, providing certain conditions are met. By way of example
h) A player may give another player a twist card 12.

a. If it is a persona card 16, the player may hand the twist card 12 to the other player prior to the other player speaking what is stated on their drawn tongue twister card 14. The other player has to speak in that particular voice type that is listed on the persona card 16, such as movie trailer voice, or the like.

b. If it is an offense card 18, the player may hand the twist card 12 to the other player before or after the other player has spoken what is on their tongue twister card 10 depending on the content and conditions specified on the offense card 18. The offense card 18 may include text such as “Current player must read their successful tongue twister again to score the Game Point”, or the like.
i) A player may give themselves a twist card 12.

a. If it is a defense card 20, the player may use the action card 16 on their own turn. The defense card 20 may include text such as “re-read your currently failed tongue twister”, or the like.

b. If it is a persona card 16, the player would speak in that particular voice type or mannerism that is listed on the title 28 and instruction area 30 of the persona card 16.

The game may be won by a variety of combinations, agreed upon by the players. For example, the winner may be defined by the first player to collect ten game points. Alternatively, by the player with the most game points when the tongue twister deck 10 has run out.

The method of playing the present game may allow for improved speech, creativity and social skills. The game may be played as a social activity, as a speech therapy tool or the like. The plurality of cards allows for variation, so that a player may stay focused on the game and continue to learn. The plurality of cards may be increased by custom made cards. New tongue twisters may be added to the plurality of tongue twister cards 10.

It should be understood, of course, that the foregoing relates to exemplary embodiments of the invention and that modifications may be made without departing from the spirit and scope of the invention as set forth in the following claims.

What is claimed is:

1. A method for playing an educational game for teaching players speech quality improvement comprising:
a. providing at least one player with a twist card;
b. picking a player to start the game;
c. drawing a tongue twister card for each player when it is the player's turn; the tongue twister card having a text of a tongue twister presented on a surface thereof;
d. the player speaking the text of the tongue twister card; and
e. collecting a game point if the tongue twister text is spoken correctly and drawing at least one twist card.

2. The method for playing an educational game of claim 1, further comprising:
playing a twist card, wherein the twist card comprises a persona card, the persona card providing an identity for a persona, wherein the player speaks the tongue twister text according to an attribute of the persona.

3. The method for playing an educational game of claim 1, further comprising:
playing a twist card, wherein the twist card comprises an offense action card, the offense action card providing an additional condition for an opponent to execute in order to collect a game point.

4. The method for playing an educational game of claim 3, further comprising:
the opponent performing the additional condition specified on the offense action card.

5. The method for playing an educational game of claim 1, further comprising:
playing a twist card, wherein the twist card comprises a defense action card, the defense action card specifying an additional condition for the player playing the defense action card to execute in order to collect a game point.

6. The method for playing an educational game of claim 5, further comprising the player playing the defense action card performing the additional condition specified on the defense action card.

7. A card game comprising:
a plurality of tongue twister cards, said tongue twister card having a text of a tongue twister presented on a surface thereof; the text of the tongue twister to be spoken by a player during the game;
a plurality of twist cards; the twist cards having indicia presented on a surface thereof, the indicia specifying an additional condition under which the player is required to execute the speaking of the tongue twister.

8. The card game of claim 7, wherein the twist card comprises a persona card, the persona card having an identity of a persona presented on a surface thereof, wherein the persona is the additional condition.

9. The card game of claim 8, wherein the persona card further comprises a presentation of an additional start or finish action as the additional condition.

10. The card game of claim 7, wherein the twist card comprises an offense action card, the offense card having a presentation of the additional condition under which an opponent is to execute the speaking of the tongue twister.

11. The card game of claim 7, wherein the twist cards comprises a defense action card, the defense action card having a presentation of the additional condition under which a player of the defense action card is to execute the speaking of the tongue twister.

12. The game of claim 7, further comprising:
a voice recognition module, wherein the voice recognition module scores a player's recitation of the text of the tongue twister.
